(19) United States
(12) Patent Application Publication
(10) Pub. No.: US 2002/0059215 A1
(43) Pub. Date: May 16, 2002

(54) Data search apparatus and method

(76) Inventors: Takuya Kotani, Kanagawa (JP); Kiyoshi Kusama, Tokyo (JP); Takashi Hanamoto, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/984,117

(22) Filed: Oct. 29, 2001

(30) Foreign Application Priority Data
Nov. 2, 2000 (JP) 2000-336608
Oct. 11, 2001 (JP) 2001-314071

(51) Int. Cl. G06F 7/00

(52) U.S. Cl. 707/3

(57) ABSTRACT

A data search apparatus for searching search object data that contains binary data and meta-data displays a list of thumbnails that indicate search object data. When a desired thumbnail is designated as search object data from this list display, meta-data contained in the designated search object data is extracted and displayed. When desired data is designated from the displayed meta-data, the designated data is set as a keyword as a search condition. A data search is executed based on the set keyword and meta-data contained in each search object data.

### FIELD OF THE INVENTION

The present invention relates to a search method and apparatus for data which contains binary data and meta-data, and a storage medium.

### BACKGROUND OF THE INVENTION

Meta-data is “data that pertains to data”, and is used as that for explaining binary data such as image data, audio data, and the like. By appending meta-data to binary data, image data, audio data, and the like can undergo a search using keywords. Today, the effectiveness of meta-data has widely prevailed, and attempts have been made to prepare meta-data for binary data in various formats and to use them in a search.

However, items and their contents described in meta-data cannot be revealed since they are described in a data description language. Since described items and their contents cannot be revealed, it is difficult to set an appropriate search keyword in a search for binary data. Binary data to be found cannot be obtained unless a search is made using an appropriate search keyword. Even if the description contents of meta-data are revealed, binary data to be found cannot be obtained unless items and their contents are clearly determined. Also, it is nearly impossible to search for binary data using a normal narrow-down search process. In an image search, an expected search result is often not clearly determined, and a general search process cannot be used in such case.

### SUMMARY OF THE INVENTION

The present invention has been made in consideration of the aforementioned problems, and has its object to allow a search with reference to meta-data of selected binary data, and also to allow a search by easily inputting an appropriate keyword.

It is another object of the present invention to flexibly cope with internal data since meta-data described in a data description language is used as objective data.

It is still another object of the present invention to provide a search scheme that can easily obtain desired image data even when an expected search result is not clearly determined in, e.g., an image search.

In order to achieve the above objects, a data search apparatus according to one aspect of the present invention comprises, e.g., the following arrangement.

That is, a data search apparatus for searching search object data that contains binary data and meta-data, comprises:

first display means for displaying information that represents the search object data in the form of a list;

designation means for designating desired search object data from the list display of the first display means;

second display means for extracting meta-data contained in the search object data designated by the designation means, and displaying the extracted meta-data;

setting means capable of setting a keyword as a search condition with reference to display contents of the second display means; and

search means for executing a data search on the basis of the keyword set by the setting means, and meta-data contained in each search object data.

In order to achieve the above objects, a data search method according to another aspect of the present invention is a data search method for searching search object data that contains binary data and meta-data, comprising:

the first display step of displaying information that represents the search object data in the form of a list;

the designation step of designating desired search object data from the list display in the first display step;

the second display step of extracting meta-data contained in the search object data designated in the designation step, and displaying the extracted meta-data;

the setting step capable of setting a keyword as a search condition with reference to display contents of the second display step; and

the search step of executing a data search on the basis of the keyword set in the setting step, and meta-data contained in each search object data.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the arrangement of an image search apparatus in the first embodiment;

FIG. 2 shows an outer appearance of the image search apparatus of the first embodiment;

FIG. 3 shows a GUI screen display example upon searching for still image data;

FIG. 4 shows an example of meta-data for still image data in the first embodiment;

FIG. 5 shows still image data appended with meta-data in search object data in the first embodiment;

FIG. 6 is a flow chart showing the sequence for searching for still image data using the GUI shown in FIG. 3;

FIG. 7 is a flow chart for explaining the control sequence in the image search apparatus of the first embodiment;

FIG. 8 is a flow chart showing an image search process in the first embodiment;

FIG. 9 shows an example when the example of meta-data shown in FIG. 4 is described in XML;

FIG. 10 is a flow chart showing the flow of a search process when a database is equipped; and

FIG. 11 is a flow chart showing the flow of a search process when a meta-data select count storage mechanism is equipped.

### DETAILED DESCRIPTION OF THE PREFERRED EMBODIMENTS

Preferred embodiments of the present invention will now be described in detail in accordance with the accompanying drawings.

<First Embodiment>

An embodiment to be described below will explain a data search apparatus which allows the user to easily input an appropriate keyword and to make an appropriate search, since it uses an idea creation-support type user interface which displays samples of binary data as search object data, and allows the user to make a search with reference to meta-data of binary data selected from display samples. In this embodiment, an image search apparatus will be explained as an example of the data search apparatus.

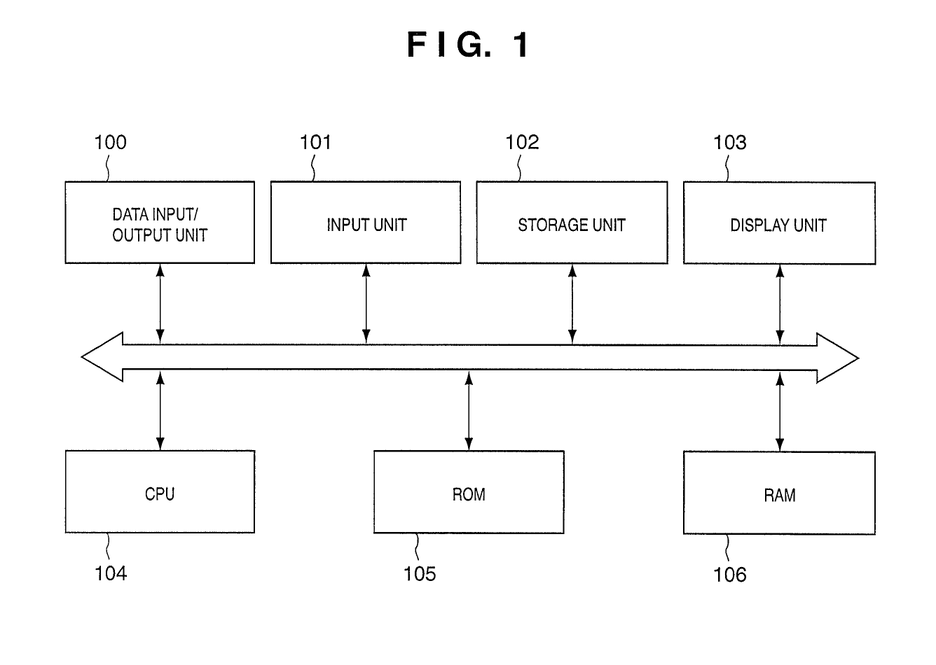

FIG. 1 is a block diagram showing the arrangement of an image search apparatus in the first embodiment. Referring to FIG. 1, a data input/output unit 100 reads data of images and the like sensed by a digital camera or the like from a memory card or the like via a PC card, USB, or the like. Also, the data input/output unit 100 writes data such as images and the like in the memory card. An input unit 101 is a device for inputting user's instructions and data, and includes a keyboard and pointing device. As the pointing device, a mouse, tracking ball, tablet, and the like may be used. A storage unit 102 is a device for storing binary data and meta-data, and normally uses a hard disk or the like. A display unit 103 is a device for displaying an image such as a GUI or the like, and normally uses a CRT, liquid crystal display, or the like.

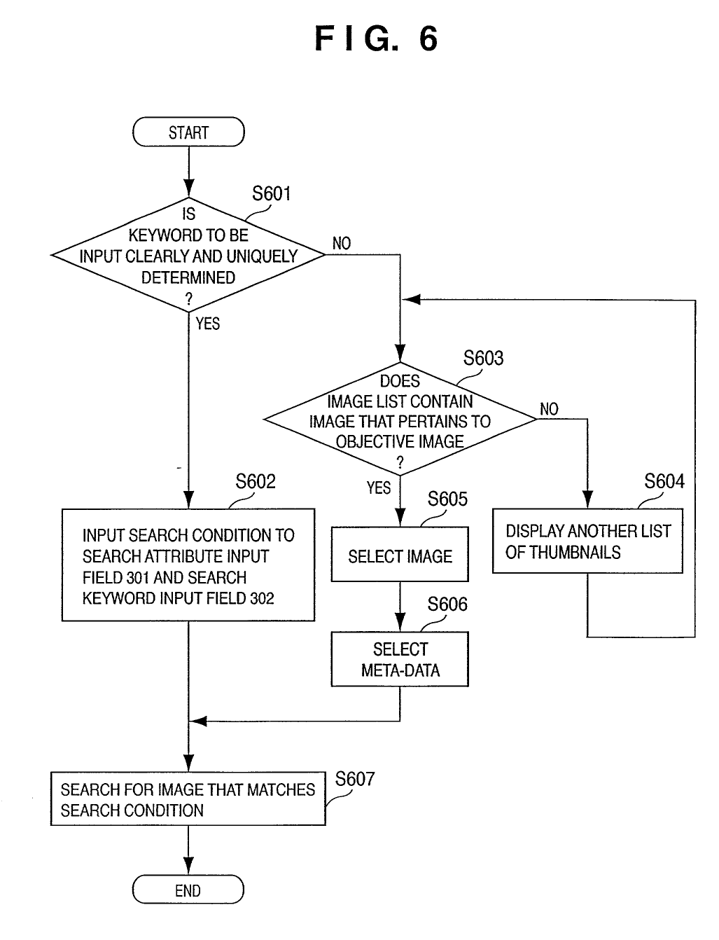

Reference numeral 104 denotes a CPU which pertains to all processes of the aforementioned components. A ROM 105 and RAM 106 provide programs, data, work area, and the like required for processes to the CPU 104. Control programs required for the processes shown in the flow charts of FIG. 6 and subsequent figures are stored in the storage unit 102 or ROM 105. When a control program is stored in the storage unit 102, it is temporarily loaded onto the RAM 106 upon execution.

The system arrangement includes various other building components in addition to those described above, but since they are not related to the present invention, a description thereof will be omitted.

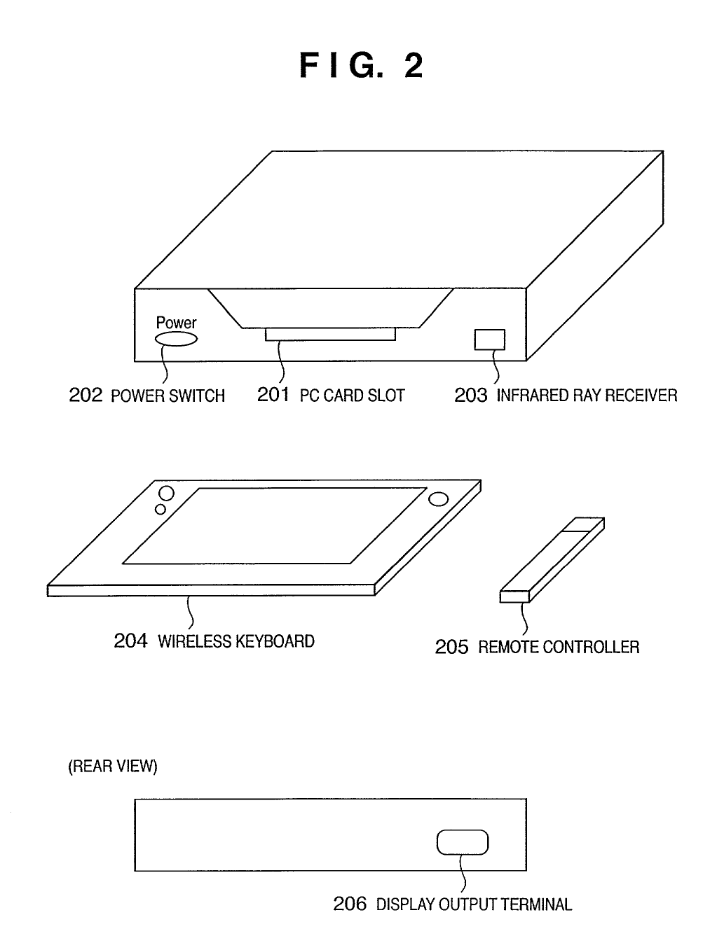

FIG. 2 shows the outer appearance of the image search apparatus of this embodiment. A PC card slot 201 is built in the front surface of the apparatus, and an image can be read via a PC card. A power switch 202 is used to operate a power supply of the apparatus. An infrared ray receiver 203 receives signals from a wireless keyboard 204 and remote controller 205. The wireless keyboard 204 and remote controller 205 form the input unit 101. A display output terminal 206 is provided to the rear surface of the apparatus, and a display device such as a CRT, liquid crystal display, or the like is connected to this terminal to form the display unit 103. In addition, a USB terminal used to connect a digital camera, a network connection terminal used to connect a network, and the like may be provided to the rear surface.

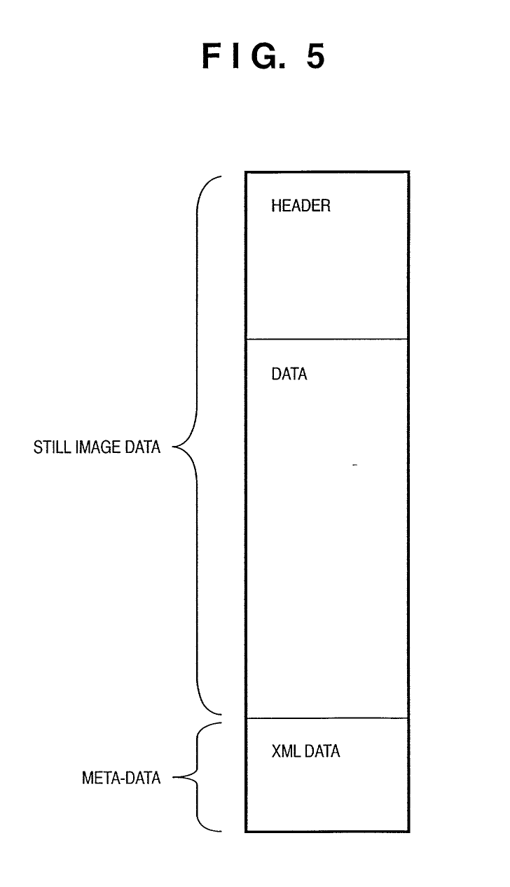

In the embodiments, data, which includes binary data and meta-data, and are the object of the search, are called, “search object data”. This embodiment will exemplify a case wherein binary data are still image data. All image data are appended in advance with meta-data described in a data description language, as shown in FIG. 5. In this embodiment, meta-data is described using XML as the data description language. Note that the types of languages that describe meta-data are not particularly limited as long as meta-data is described in the data description language, and for example, HTML, SGML, and the like may be used.

In this embodiment, since meta-data is appended after still image data, as shown in FIG. 5, it does not influence a still image data process of an existing application. More specifically, since meta-data is connected after still image data (binary data), the user can review the still image data using an existing application.

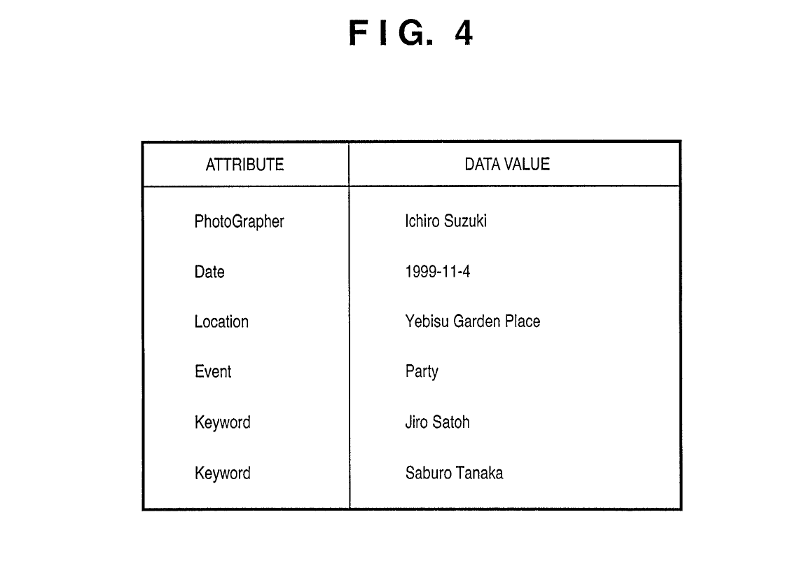

In this embodiment, meta-data to be appended to still image data is expressed by pairs of data attributes and data values, as shown in FIG. 4. In the example of FIG. 4, meta-data includes five attributes “PhotoGrapher”, “Date”, “Location”, “Event”, and “Keyword”, and a photographer's name, photographing date, photographing location, event name at the photographing location, and object names are respectively described as their data values in correspondence with “PhotoGrapher”, “Date”, “Location”, “Event”, and “Keyword”.

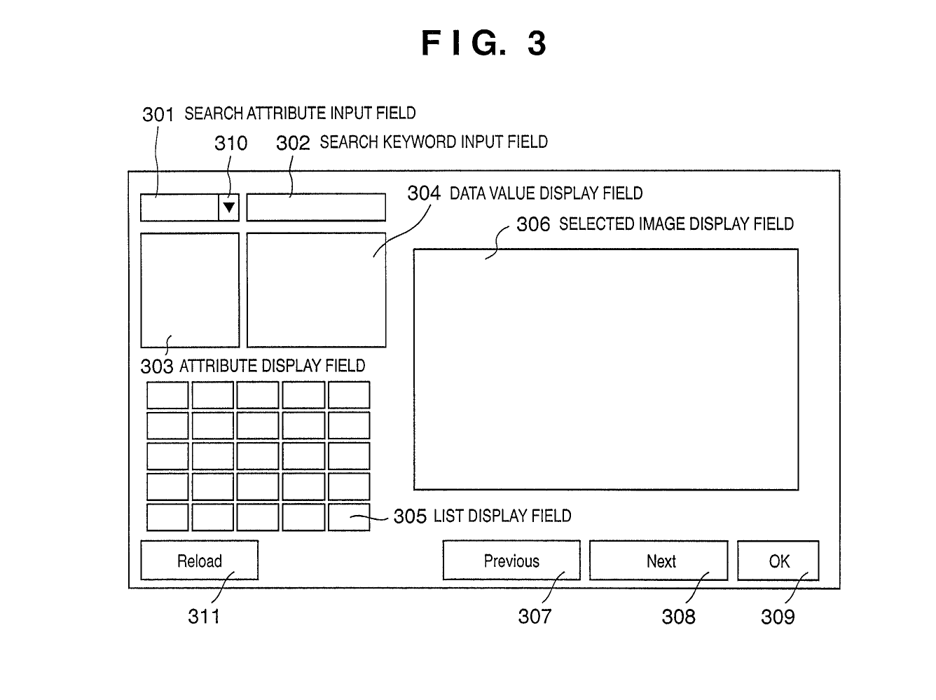

FIG. 3 shows a GUI screen display example upon searching for still image data.

As described above, in an image search, an expected search result is not often clearly determined, and a simple narrow-down search is not suitably used in such case.

In an image search scheme according to this embodiment, an image is randomly extracted and displayed from test images in a default state, and if the user is not interested in the displayed image, he or she can repeat random selection using a reload button 311 until an image that has an appeal to the user is displayed.

If the user selects an image he or she likes, the attributes of meta-data appended to that image are displayed on an attribute display field 303 and the attribute values of the meta-data are displayed on a data value display field 304. When the user selects arbitrary meta-data from the displayed meta-data, all search object data can be searched using the selected meta-data as a search keyword.

A search result is displayed on a list display field 305. When the user re-selects an image of his or her choice from those displayed on the list display field 305 as the search result, attribute of meta-data appended to that image are displayed on the attribute display field 303 and their attribute values are displayed on the data value display field 304. The user may select another image or may select meta-data to make a search under another condition.

A characteristic feature of the image search apparatus according to this embodiment lies in that when the user selects an arbitrary thumbnail image from those displayed in the form of a list, a list of meta-data of the selected image is displayed, and the user can arbitrarily select meta-data to be used in a search from the displayed meta-data.

Upon displaying a list of meta-data, data may be sorted by the following method in place of being displayed in a predetermined order or alphabetical order, thus improving operability.

(1) Counts of selection by the user are stored for respective attributes of meta-data, and meta-data are sorted and displayed in descending order of count of attributes, or

(2) counts of selection by the user are stored for respective attribute values of meta-data, and meta-data are sorted and displayed in descending order of count of attribute values.

Respective fields in FIG. 3 will be explained in detail below.

A search condition input field used to input a search condition upon searching for still image data has a search attribute input field 301 and search keyword input field 302, and the user can input a search condition that pertains to meta-data using this search condition input field. The search attribute input field 301 is used to designate the aforementioned attribute of meta-data as a search condition, and the search keyword input field 302 is used to designate the aforementioned data value as a search condition. Note that a list of known attributes at that time can be displayed by pressing an inverted triangle button 310 located at the right end of the search attribute input field 301.

A meta data display field has an attribute display field 303 and data value display field 304. The attribute display field 303 and data value display field 304 respectively display the attributes and data values of meta-data of an image corresponding to a selected one of thumbnails displayed on a list display field 305. By clicking a data value displayed on this data value display field 304, the attribute and data value of the clicked data can be designated as a search condition.

The list display field 305 displays a list of n thumbnails randomly selected from images that match a search condition, and the user can select an image by clicking a desired thumbnail from the displayed list. In an initial state, since no search condition is designated, thumbnails corresponding to n images selected from all test still image data are displayed. When a search condition is designated, thumbnails corresponding to n images selected from still image data that match the search condition are displayed. In this embodiment (FIG. 3), a maximum number of thumbnails that can be simultaneously displayed on the list display field 305 is 25. Upon pressing the reload button 311, a list of next n images can be displayed.

A selected image display field 306 displays an image selected from the list display field 305. Using previous and next buttons 307 and 308, images before and after the currently selected image in a thumbnail array can be selected and reviewed. Using an OK button 309, this GUI is ended.

FIG. 6 is a flow chart showing the sequence for searching for still image data using the GUI shown in FIG. 3. As described above, the list display field 305 displays thumbnails of 25 still image data randomly selected from all test still image data in an initial state.

If the user has already recognized a keyword contained in meta-data of still image data to be found, i.e., a keyword to be input is clearly and uniquely determined in step S601, the flow advances to step S602. In step S602, the user inputs a search keyword using the search keyword input field 302, thus setting the input keyword and its attribute as a search condition. After that, the flow advances to step S607 to search for an image that matches the set search condition.

On the other hand, if a search keyword is not clearly determined in step S601, the flow advances to step S603. In step S603, the user searches the thumbnails displayed on the list display field 305 for, e.g., still image data sensed in the same situation as that of still image data to be found. If still image data sensed in the same situation is not included in the list, the flow advances to step S604, and the user presses the reload button 311 to display another list of thumbnails, thus obtaining another randomly selected 25 thumbnails.

If the user finds, in the list, still image data sensed in the same situation as that of the still image data to be found while switching the contents of the list display field 305, the flow advances to step S605. The user clicks that thumbnail to select still image data in step S605. The selected still image data is displayed on the selected image display field 306, and the attributes and data values of meta-data of the selected still image data are respectively displayed on the attribute display field 303 and data value display field 304. The user then clicks and selects an appropriate one of keywords displayed on the data value display field 304 in step S606. In this way, the selected keyword and its attribute are set as a search condition. Since the search condition is set in this manner, the user can set the search condition without directly inputting any search keyword. After that, the flow advances to step S607 to make an image search according to the search condition.

In step S606, the user selects a keyword in the data value display field 304 using the pointing device. However, the keyword designation method is not limited to such specific method. For example, the user may input a desired keyword to the search keyword input field 302 with reference to those displayed in the data value display field 304. Furthermore, as a method of selecting data displayed in the data value display field 304, serial numbers may be assigned to data values to be displayed on the data value display field 304, and the user may input that number to select data. That is, the user may select a keyword using the corresponding number.

In the above description, one selected binary data is displayed upon displaying meta-data. Alternatively, meta-data of an arbitrary number of selected binary data may be displayed.

(1) When one binary data is selected, the data values of its meta-data are displayed on the data value display field 304, and the selected binary data is displayed on the selected image display field 306.

(2) When two or more binary data are selected, the data values of meta-data set for all the selected data are displayed on the data value display field 304, and corresponding binary data are displayed using different windows by additionally providing a [VIEW] button.

When two or more binary data are selected, the data values of meta-data set for all the selected data are displayed on the data value display field 304. If identical data are set for a plurality of binary data, those data may be identifiably displayed using a display color different from a normal text display color.

As described above, in step S607, a search is made in accordance with the search condition set in step S602 or S606. Details of this search process will be described later. Thumbnails of 25 still image data randomly selected from those obtained as the search result (that match the search condition) are displayed on the list display field 305 as the search result.

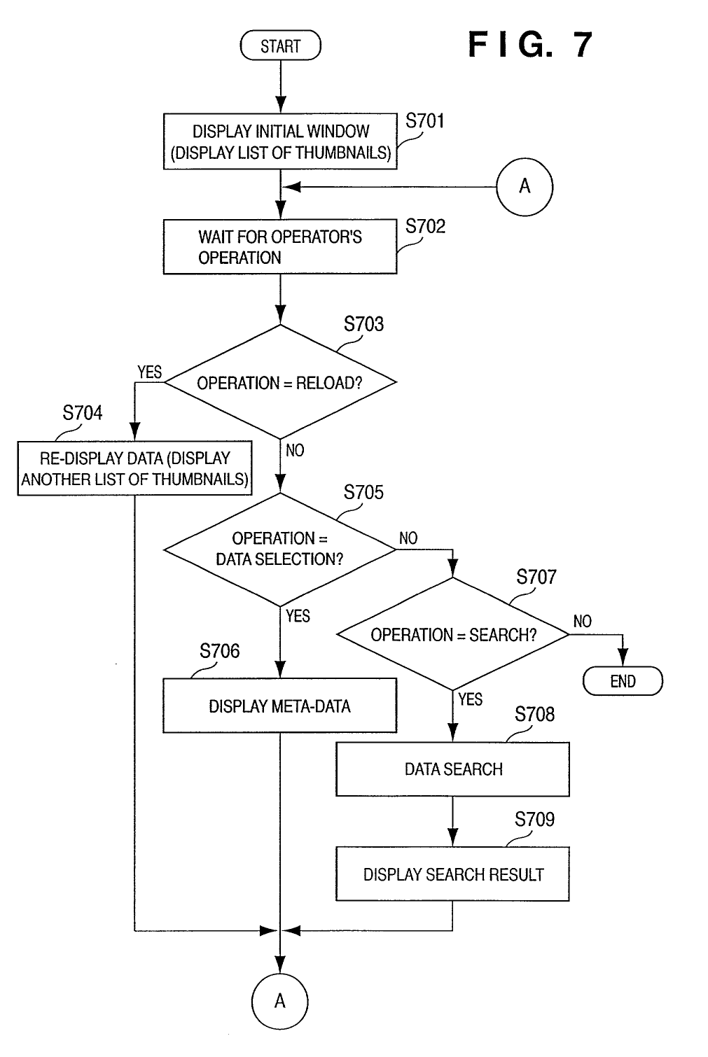

The flow of the processing of the system that implements the aforementioned processes and operations is as shown in, e.g., FIG. 7. FIG. 7 is a flow chart for explaining the control sequence in the image search apparatus of this embodiment. In the following description, data formed by still image data and meta-data, as shown in FIG. 5, will be referred to as search object data.

In step S701, thumbnails of still images contained in search object data are displayed as a list on the list display field 305. Still image data displayed as thumbnails are 25 still images contained in 25 search object data randomly selected from all search object data registered in a database. In step S702, the process waits for operation inputs of the operator via the GUI. If the operator has made some operation, the flow advances to step S703.

It is checked in step S703 if the operator has pressed the reload button 311. If YES in step S703, the flow advances to step S704; otherwise, the flow advances to step S705. If the reload button 311 has been pressed, search object data is selected in the same sequence as in step S701, and thumbnails corresponding to still image data contained in the selected search object data are displayed on the list display field 305 in step S704. After that, the flow advances to step S702 to wait for another GUI operation of the operator.

On the other hand, if the operator has directly selected a thumbnail displayed on the list display field 305 or has pressed the previous or next button 307 or 308 to select another thumbnail, the flow advances to step S706 via steps S703 and S705. In step S706, meta-data is extracted from search object data corresponding to the selected thumbnail, and the attributes and data values of that meta-data are displayed on the meta-data display field including the attribute display field 303 and data value display field 304. Upon completion of the process in step S706, the flow returns to step S702 to wait for another GUI operation of the operator.

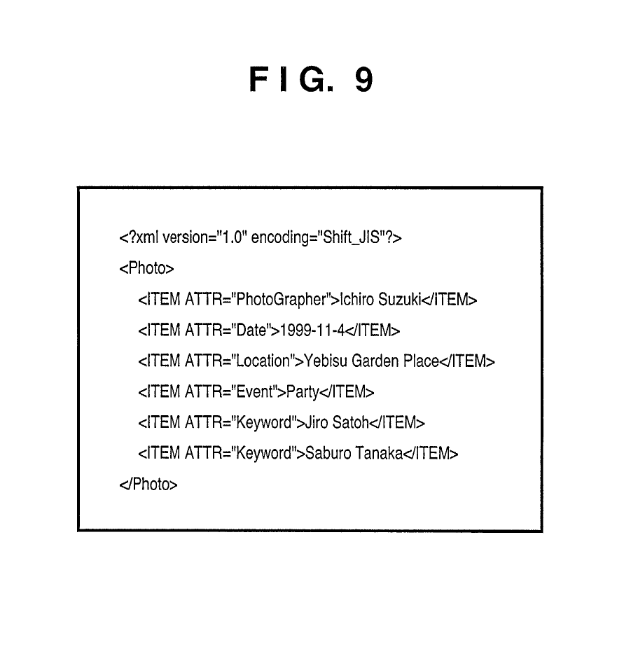

Note that the meta-data is extracted from the search object data in step S706 as follows. In the format of this embodiment, meta-data described in XML is appended after still image data, as shown in FIG. 5. Meta-data is described, as shown in FIG. 9. Therefore, a portion sandwiched between </Photo> and <Photo> is searched from the very end of that data file and is extracted, thus extracting meta-data.

Furthermore, if the operator has selected data on the data value display field 304 or has input a keyword to the search keyword input field 302, that operation is considered as a search operation for instructing the start of a search, and the flow advances to step S708 via steps S703, S705, and S707. Note that the search attribute input field 301 and button 310 are equipped to designate an attribute as a search condition. However, this embodiment does not use any attribute of meta-data in a search. Therefore, if the operator has made operation for the search attribute input field 301 and attribute display field 303, the flow returns to step S702 without any process. In this embodiment, since an operation prepared other than those detected in steps S703, S705, and S707 is only pressing of the OK button 309, the GUI ends in such case.

In step S708, search object data are searched using the data value of the meta-data designated in step S707 as a search keyword. In step S709, the search result is displayed. Upon completion of the process in step S709, the flow returns to step S702 to wait for another GUI operation of the operator. In step S709, thumbnails corresponding to still image data contained in 25 search object data randomly selected from the search result are displayed as a list on the list display field 305. Therefore, if the reload operation has been made in step S703, and the flow advances to step S704, another list of thumbnails is generated based on the search object data obtained as the search result. Upon displaying the search result, a predetermined number of data (25 data in this embodiment) may be selected in descending order of search likelihood (similarity), and may be displayed on the list display field 305.

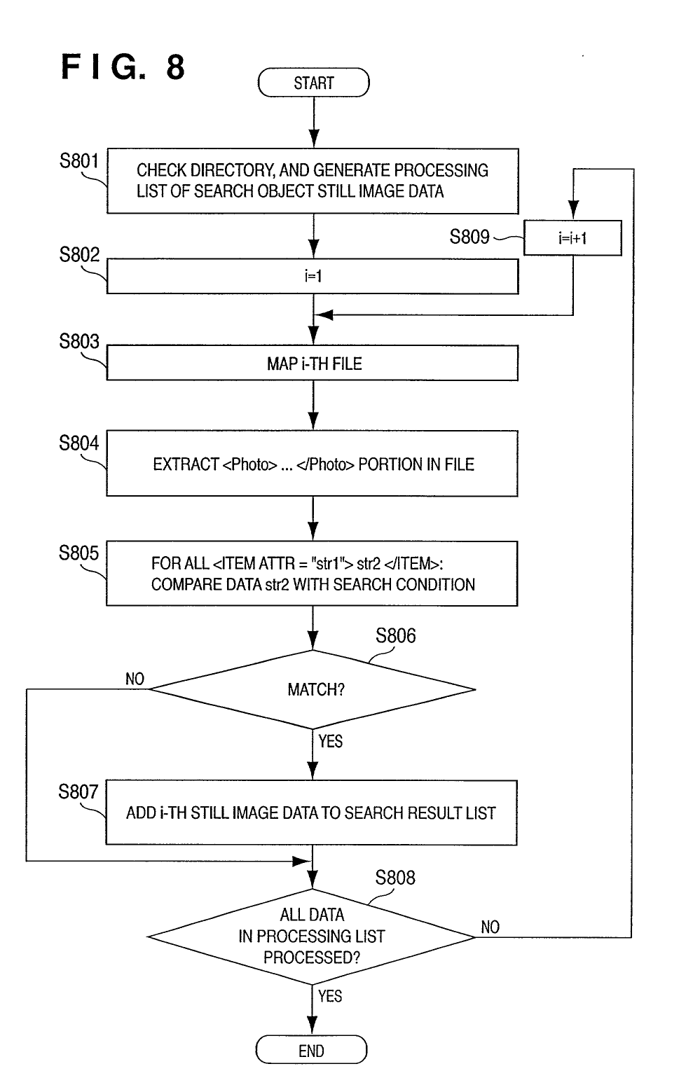

The search process in step S708 will be described below. FIG. 8 is a flow chart showing the image search process of this embodiment. Note that still image data as search object data are stored in a predetermined directory or its subdirectory. As described above, meta-data described in the data description language are appended in advance to all search object data, as shown in FIG. 5.

In step S801, the directory where search object data are stored is checked to generate a processing list of search object data. In step S802, “1” is set in counter i for the processing list. In step S803, still image data contained in a file of the i-th search object data in the processing list is mapped. In step S804, meta-data contained in that search object data is extracted.

Note that XML tags used in definition of meta-data are not particularly limited. For example, this embodiment uses delimiters <Photo>and </Photo>, as shown in FIG. 9. FIG. 9 shows an example of the meta-data shown in FIG. 4 described in XML. In this embodiment, since meta-data is appended after still image data, meta-data delimited by <Photo> and </Photo> can be searched from the very end of the search object data. After the meta-data is extracted, the flow advances to step S805. In step S805, the attributes and data values of the meta-data are extracted, and are compared with the search condition. The definition of meta-data is not particularly limited. For example, in this embodiment, assume that attribute str1 and data value str2 of meta-data are described by:

<ITEM ATTR=“str1”> str2</ITEM>

The extracted meta-data is compared with the search condition. For example, in this embodiment, it is checked if str2 matches the data value of the search keyword. In this way, since only the data value of meta-data is to be compared, and the attribute is not compared, a more flexible search can be made. In order to attain a stricter search, matches between str1 and the attribute of the search keyword and between str2 and the data value of the search keyword may be checked.

It is checked in step S806 if a description of meta-data that matches the search condition is found. If YES in step S806, the flow advances to step S807, and the i-th search object data is registered in a search result list. After that, the flow advances to step S808. It is checked in step S808 if the aforementioned processes have been executed for all search object data registered in the processing list. If YES in step S808, the search process ends; otherwise, the value i is incremented by one, and the flow returns to step S803.

If no meta-data is detected in step S804, since meta-data is not appended to that still image data, the flow may skip the processes in steps S805 to S807 and directly jump to step S808.

As described above, according to this embodiment, meta-data appended to the designated still image data is displayed, and a search keyword can be set by selecting desired data from the displayed contents. For this reason, even when the user does not know any keywords set as meta-data of still image data, he or she can easily set an appropriate search keyword and find required still image data.

<Second Embodiment>

The second embodiment will explain a case wherein the data values of meta-data to be displayed on the data value display field are sorted in accordance with a predetermined condition. This embodiment will describe processes executed when a select count of each meta-data is stored, as described above, and meta-data are sorted in descending order of meta-data select count by the user upon displaying meta-data of a selected thumbnail image.

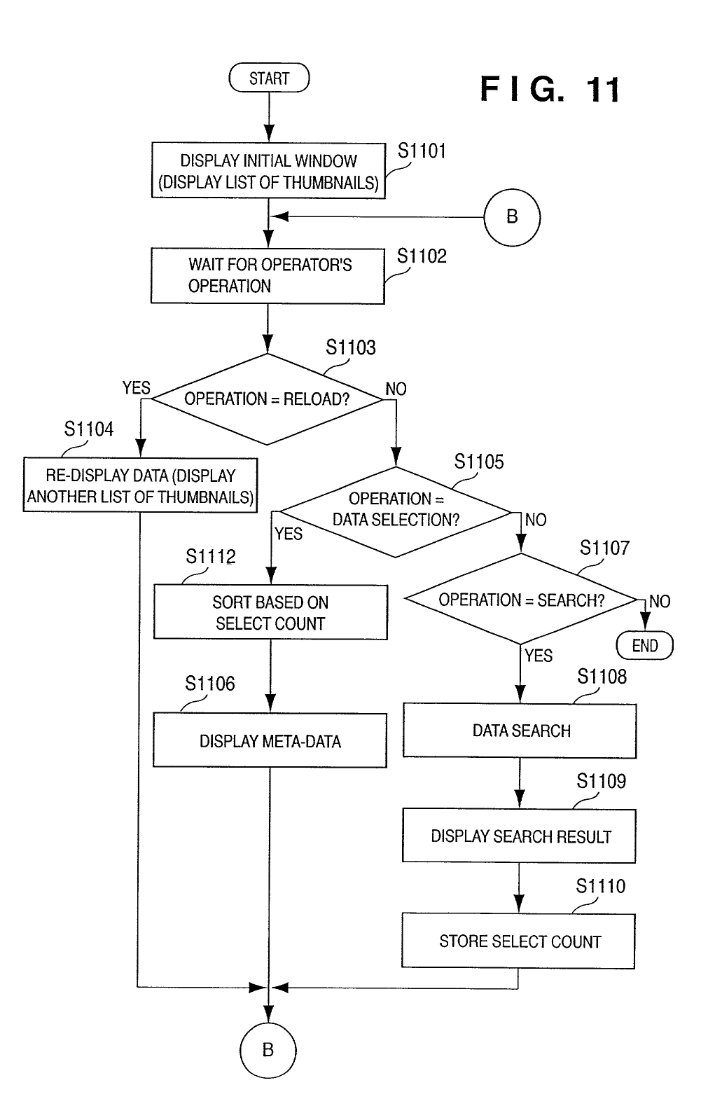

FIG. 11 is a flow chart showing the flow of the search process when the meta-data select count is stored, and meta-data are sorted in descending order of select count upon display. The basic flow of the processes is the same as that described with reference to FIG. 7 (the processes in step S1101 to S1109 in FIG. 11 are the same as those in steps S701 to S709 in FIG. 7). There are two differences from FIG. 7.

First, if it is determined in step S1107 (step S707 in FIG. 7) that operator's meta-data select operation instructs “search”, a data search is made in the processes in FIG. 7 to display the search results (steps S708 and S709), and-the control returns to a state (step S702) that waits for another operator's operation. By contrast, in the processes in FIG. 11, a process for storing the meta-data select count is executed (step S1110) in addition to the data search and the search result display process (steps S1108 and S1109), and the control then returns to a state (step S1102) that waits for another operator's operation. The process for storing the select count is a process for holding the number of times the meta-data is selected. In this embodiment, for example, select counts for respective attribute values of meta-data are held. The result of this process is used in a sort process in step S1112. However, if the sort process does not use the select counts of meta-data, that process may be omitted.

Second, if it is determined in step S1105 (step S705 in FIG. 7) that operator's meta-data select operation is “data selection”, only a meta-data display process (step S706) is executed and the control returns to a state (step S702) that waits for another operator's operation in the processes shown in FIG. 7. By contrast, in the processes in FIG. 11, a process for sorting meta-data to be displayed (step S1112) is executed before the meta-data display process (step S1106). The sort condition in this sort process is not particularly limited. In this embodiment, meta-data are sorted using the select counts (counted in step S1109) of attribute values by the operator.

<Third Embodiment>

In the description of the first and second embodiments, the search method of still image data as search object data which are stored under a given directory has been explained. However, when the number of still image data as search object data becomes large, a very long search time is required if files are opened one by one as in the first and second embodiments. Hence, search object data which are to undergo a search may be stored in a database in advance, and the database may be searched.

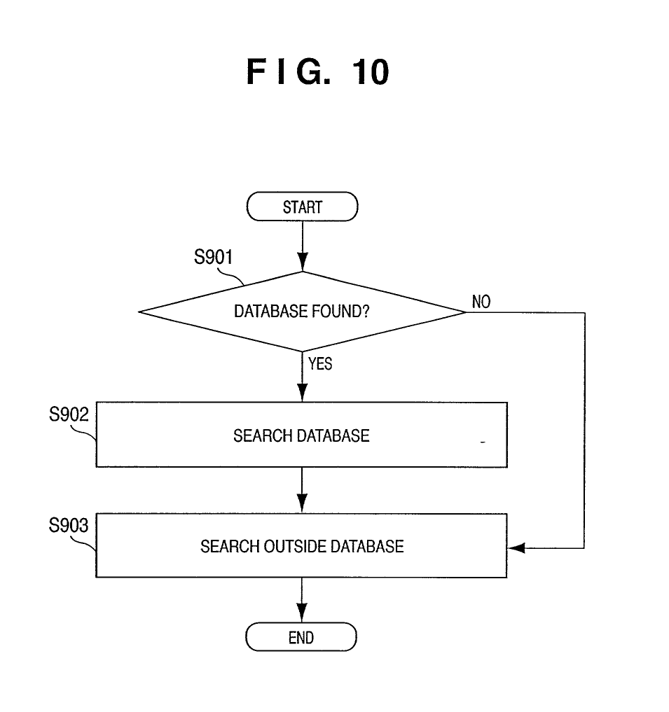

FIG. 10 is a flow chart showing the flow of the search process (the process in step S708 or S1108) when the database is equipped. It is checked in step S901 if a database is present. If a database is found, it is also confirmed if that database is not broken. If the database is found and is searchable, the flow advances to step S902; otherwise, the flow advances to step S903. In step S902, the database is searched to obtain a search result list of search object data that matches the search condition. Note that search object data which are not registered in the database may be present, and the flow advances to step S903. In step S903, search object data stored under a given directory undergo the same search process as in FIG. 8.

Since a search is made using the database, the search time can be shortened if the number of search object data is large. Even if data in the database are broken, since meta-data remain in search object data themselves, it is easy to re-create a database. That is, when meta-data according to this embodiment is recorded in a single file together with corresponding binary data, and it is found that data in the database are broken, meta-data appended to data stored under a predetermined directory are read again, and can be re-registered in the database. In the first embodiment, data stored under a predetermined directory undergo a search, i.e., files stored under the predetermined directory are read out one by one to extract meta-data, and it is checked if the extracted meta-data matches a search keyword. However, in the third embodiment, a search using the database, i.e., a search that exploits the search function of the database itself is made.

In each of the above embodiments, still image data has been exemplified as binary data to which meta-data is appended and serves as search object data. In addition, the present invention can be applied to moving image data and audio data. When the present invention is applied to moving image data as binary data, thumbnails to be displayed on the list display field 305 can be generated as follows. That is, one frame is extracted from moving image data, and a thumbnail of that frame is generated and used in a list display. In this case, a moving image contained in selected search object data may be played back on the selected image display field 306. On the other hand, when the present invention is applied to audio data as binary data, selected audio data may be played back in place of displaying it on the selected image display field 306.

In the above embodiments, thumbnails are displayed on the list display field 305. Alternatively, a list of file names may be displayed. Especially, when audio data are used as test binary data, a list of file names may be displayed.

In the above embodiments, designation of a thumbnail on the list display field 305, designation of a keyword on the data value display field 304, or operations of various buttons may be made using a pointing device such as a mouse, track ball, tablet, or the like, via a touch panel overlaid on the display screen, or using a software keyboard.

When the user directly inputs a condition (keyword) to the search attribute input field 301 or search keyword input field 302, speech input (requires a speech recognition process) or barcode input may be used in addition to input by means of a keyboard, or a software keyboard may be used.

Note that the present invention may be applied to either a system constituted by a plurality of devices (e.g., a host computer, an interface device, a reader, a printer, and the like), or an apparatus consisting of a single equipment (e.g., a copying machine, a facsimile apparatus, or the like).

The objects of the present invention are also achieved by supplying a storage medium, which records a program code of a software program that can implement the functions of the above-mentioned embodiments to the system or apparatus, and reading out and executing the program code stored in the storage medium by a computer (or a CPU or MPU) of the system or apparatus.

In this case, the program code itself read out from the storage medium implements the functions of the above-mentioned embodiments, and the storage medium which stores the program code constitutes the present invention.

As the storage medium for supplying the program code, for example, a floppy disk, hard disk, optical disk, magneto-optical disk, CD-ROM, CD-R, magnetic tape, nonvolatile memory card, ROM, and the like may be used.

The functions of the above-mentioned embodiments may be implemented not only by executing the readout program code by the computer but also by some or all of actual processing operations executed by an OS (operating system) running on the computer on the basis of an instruction of the program code.

Furthermore, the functions of the above-mentioned embodiments may be implemented by some or all of actual processing operations executed by a CPU or the like arranged in a function extension board or a function extension unit, which is inserted in or connected to the computer, after the program code read out from the storage medium is written in a memory of the extension board or unit.

To restate, according to the present invention, an appropriate search keyword can be easily input, and an efficient search can be made.

Since vaguely defined images are extracted by reloading, and selection of meta-data and images are repeated using that extraction result as a default state, even a user who does not clearly have an image to be found can search for an image of his or her favor by following the search results. Such idea creation-support type search cannot be implemented by a normal narrow-down search. Especially, an expected search result is often not clearly determined in an image search, and the search method of the present invention is effective in such case.

Furthermore, the present invention can be applied to the system comprising either a plurality of units or a single unit. It is needless to say that the present invention can be applied to the case which can be attained by supplying programs which execute the process defined by the present system or invention.

As many apparently widely different embodiments of the present invention can be made without departing from the spirit and scope thereof, it is to be understood that the invention is not limited to the specific embodiments thereof except as defined in the claims.

What is claimed is:

1. A data search apparatus for searching search object data that contains binary data and meta-data, comprising:
first display means for displaying information that represents the search object data in the form of a list;
designation means for designating desired search object data from the list display of said first display means;
second display means for extracting meta-data contained in the search object data designated by said designation means, and displaying the extracted meta-data;
setting means capable of setting a keyword as a search condition with reference to display contents of said second display means; and
search means for executing a data search on the basis of the keyword set by said setting means, and meta-data contained in each search object data.

2. The apparatus according to claim 1, wherein the binary data is one of still image data, moving image data, and audio data.

3. The apparatus according to claim 1, wherein the meta-data is described in a data description language selected from XML, HTML, and SGML.

4. The apparatus according to claim 1, wherein the search object data has a format in which the meta-data is connected after the binary data.

5. The apparatus according to claim 1, wherein the meta data is described to be delimited by predetermined start and end tags, and said second display means extracts the meta-data by detecting the start and end tags.

6. The apparatus according to claim 1, wherein said first display means displays file names of search object data in the form of a list.

7. The apparatus according to claim 1, wherein the binary data is still image data, and said first display means displays thumbnails of still image data contained in search object data in the form of a list.

8. The apparatus according to claim 1, wherein the binary data is moving image data, and said first display means displays thumbnails of frames extracted from moving image data in the form of a list.

9. The apparatus according to claim 1, wherein said setting means designates the keyword by designating desired data from the meta-data displayed by said second display means.

10. The apparatus according to claim 1, wherein the search object data are stored in a predetermined logical area in a memory.

11. The apparatus according to claim 1, wherein the search object data are registered in a database.

12. The apparatus according to claim 1, wherein said second display means displays meta-data of an arbitrary number of search object data designated by said designation means.

13. The apparatus according to claim 1, wherein said second display means displays keywords contained in the meta-data together with numbers, and said setting means sets a desired keyword by the number.

14. The apparatus according to claim 1, wherein said second display means sorts and displays meta-data to be displayed in accordance with a predetermined condition.

15. The apparatus according to claim 1, wherein said first display means displays information indicating a predetermined number of search object data randomly selected from all search object data before execution of said search means, and displays information indicating a predetermined number of search object data selected from the search object data found as a search result after execution of said search means.

16. A data search method for searching search object data that contains binary data and meta-data, comprising:
the first display step of displaying information that represents the search object data in the form of a list;
the designation step of designating desired search object data from the list display in the first display step;
the second display step of extracting meta-data contained in the search object data designated in the designation step, and displaying the extracted meta-data;
the setting step capable of setting a keyword as a search condition with reference to display contents of the second display step; and
the search step of executing a data search on the basis of the keyword set in the setting step, and meta-data contained in each search object data.

17. The method according to claim 16, wherein the binary data is one of still image data, moving image data, and audio data.

18. The method according to claim 16, wherein the meta-data is described in a data description language selected from XML, HTML, and SGML.

19. The method according to claim 16, wherein the search object data has a format in which the meta-data is connected after the binary data.

20. The method according to claim 16, wherein the meta data is described to be delimited by predetermined start and end tags, and the second display step includes the step of extracting the meta-data by detecting the start and end tags.

21. The method according to claim 16, wherein the first display step includes the step of displaying file names of search object data in the form of a list.

22. The method according to claim 16, wherein the binary data is still image data, and the first display step includes the step of displaying thumbnails of still image data contained in search object data in the form of a list.

23. The method according to claim 16, wherein the binary data is moving image data, and the first display step includes the step of displaying thumbnails of frames extracted from moving image data in the form of a list.

24. The method according to claim 16, wherein the setting step includes the step of designating the keyword by designating desired data from the meta-data displayed in the second display step.

25. The method according to claim 16, wherein the search object data are stored in a predetermined logical area in a memory.

26. The method according to claim 16, wherein the search object data are registered in a database.

27. The method according to claim 16, wherein the second display step displays meta-data of an arbitrary number of search object data designated in the designation step.

28. The method according to claim 16, wherein the second display step includes the step of displaying keywords contained in the meta-data together with numbers, and the setting step includes the step of setting a desired keyword by the number.

29. The method according to claim 16, wherein the second display step includes the step of sorting and displaying meta-data to be displayed in accordance with a predetermined condition.

30. The method according to claim 16, wherein the first display step includes the step of displaying information indicating a predetermined number of search object data randomly selected from all search object data before execution of the search step, and the step of displaying information indicating a predetermined number of search object data selected from the search object data found as a search result after execution of the search step.

31. A computer readable medium that stores a control program for making a computer execute a data search for searching search object data that contains binary data and meta-data, said control program comprising:
a code of the first display step of displaying information that represents the search object data in the form of a list;
a code of the designation step of designating desired search object data from the list display in the first display step;
a code of the second display step of extracting meta-data contained in the search object data designated in the designation step, and displaying the extracted meta-data;
a code of the setting step capable of setting a keyword as a search condition with reference to display contents of the second display step; and
a code of the search step of executing a data search on the basis of the keyword set in the setting step, and meta-data contained in each search object data.
